(19) United States
(12) Patent Application Publication
(10) Pub. No.: US 2022/0380020 A1
(43) Pub. Date: Dec. 1, 2022

(54) METHOD FOR ASSISTING THE PILOTING OF A ROTORCRAFT COMPRISING AT LEAST TWO ENGINES

(71) Applicant: AIRBUS HELICOPTERS, Marignane Cedex (FR)

(72) Inventors: Guillaume RAYNAUD, Marseille (FR); Nicolas CALMES, Salon De Provence (FR)

(73) Assignee: AIRBUS HELICOPTERS, Marignane Cedex (FR)

(21) Appl. No.: 17/745,534

(22) Filed: May 16, 2022

(30) Foreign Application Priority Data
May 31, 2021 (FR) 2105645

(51) Int. Cl. B64C 13/02; B64C 1/00; B64D 35/08; B64C 27/00; B64D 45/08

(52) U.S. Cl. CPC B64C 13/02; B64C 1/0009; B64D 35/08; B64C 27/006; B64D 45/08

(57) ABSTRACT

A method for assisting the piloting of a rotorcraft including at least two engines capable of transmitting engine torque to at least one main rotor, the assistance method comprising the following steps: periodically determining a current position of the rotorcraft; making a first periodic comparison between the current position and a decision point; identifying an engine failure; making a second periodic comparison between the current position of the rotorcraft and a touchdown point; periodically determining an emergency landing profile, the emergency landing profile being generated at least depending on a result of the second periodic comparison; and periodically generating control orders to pilot the rotorcraft according to the emergency landing profile.

### CROSS REFERENCE TO RELATED APPLICATIONS

This application claims priority to French patent application No. FR 21 05645 filed on May 31, 2021, the disclosure of which is incorporated in its entirety by reference herein.

### TECHNICAL FIELD

The present disclosure relates to a method for assisting the piloting of a rotorcraft that can be implemented during a take-off or landing phase of the rotorcraft.

### BACKGROUND

Such a rotorcraft comprises at least two engines, for example heat and/or electric engines, and such an assistance method may make it possible to assist a pilot in order to carry out a manoeuvre according to a Category A procedure for piloting the rotorcraft. Such a procedure may in particular consist of a take-off or landing phase placing very high demands on the performance of the at least two engines.

Such known piloting assistance methods are described, in particular, in documents U.S. Pat. Nos. 6,527,225 and 6,629,023 and are applied respectively during a take-off phase and during a landing phase.

In this case, if one of the engines fails during one of these phases, the assistance system implementing such an assistance method may then make it possible to pilot the rotorcraft by following an emergency landing profile in order to reach a predetermined touchdown point. Such a profile then includes a three-dimensional fallback path that the rotorcraft must follow at all times.

However, under certain conditions, it may prove to be complex, or even impossible, for the rotorcraft to follow such a three-dimensional path. Moreover, the constraints linked to the weight of the equipment on board a rotorcraft also act as a brake.

Other methods for assisting the piloting of a rotorcraft during a take-off phase are also known, as described in documents EP 3 444 696 and FR 2 900 385.

More particularly, document EP 3 444 696 relates to a system and a method for providing a pilot with guidance cues in order to carry out a Category A take-off manoeuvre with a rotorcraft.

The flight management system instructs the pilot to take off and then increase the collective pitch and apply lateral control to the cyclic pitch control stick in order to perform a slow lateral climb towards a decision point.

If the rotorcraft experiences an engine failure before reaching the decision point, the take-off procedure is aborted.

In addition, the system instructs the pilot to begin a descent and then provides the pilot with cues both to maintain an acceptable rotor speed and keep the rotorcraft in a substantially horizontal attitude.

### SUMMARY

An object of the present disclosure is therefore to propose an alternative piloting assistance method that helps overcome the above-mentioned limitations. Such an assistance method may be implemented during both take-off or landing of the rotorcraft.

One aim of the disclosure is therefore, in particular, to be able to ensure the implementation of an emergency landing phase for a rotorcraft.

The disclosure therefore relates to a method for assisting the piloting of a rotorcraft including at least two engines capable, in the absence of a failure, of transmitting engine torque to at least one main rotor providing at least lift keeping the rotorcraft in the air, the rotorcraft comprising aerodynamic members for piloting the rotorcraft, the assistance method including the following steps:

periodically determining a current position of the rotorcraft;

making a first periodic comparison between the current position and a decision point, the first periodic comparison enabling to determine that the current position of the rotorcraft has a current height less than a predetermined height of the decision point;

identifying an engine failure in at least one of the at least two engines;

making a second periodic comparison between the current position of the rotorcraft and a touchdown point;

periodically determining an emergency landing profile, the emergency landing profile being generated at least depending on a result of the second periodic comparison, the periodic determination of the emergency landing profile depending on a minimum speed of rotation (NRmin) of the at least one main rotor; and

periodically generating control orders to control the aerodynamic members and pilot the rotorcraft according to the emergency landing profile, the periodic generation of control orders being implemented when the current position of the rotorcraft has a current height less than the predetermined height of the decision point, and an engine failure is identified.

The emergency landing profile is therefore separate from a path to be followed, but makes it possible to directly manage the lift of a rotary wing of the rotorcraft at least by means of the minimum speed of rotation (NRmin) of the at least one main rotor below which the current speed of rotation of the at least one main rotor must not fall.

The control orders are then generated at least to keep the current speed of rotation of the main rotor or rotors greater than, or equal to, the minimum speed of rotation (NRmin).

In addition, according to a first embodiment, the periodic generation of control orders may be carried out completely automatically by an automatic flight control system.

According to a second embodiment, the periodic generation of control orders may be carried out partially automatically by an automatic flight control system and partially manually by a pilot of the rotorcraft.

In this case, and according to one possibility, when the current height of the rotorcraft is greater than a predetermined threshold value, the periodic generation of control orders may be carried out automatically by the automatic flight control system.

However, when the current height of the rotorcraft is, or becomes, less than or equal to the predetermined threshold value, the automatic flight control system may be inhibited in order to allow a pilot of the rotorcraft to manually generate control orders.

According to a first embodiment, the first periodic comparison between the current position and the decision point may be carried out automatically.

According to a second embodiment compatible with the first embodiment, the first periodic comparison between the current position and the decision point may also be carried out depending on a manual activation step carried out by a member of the crew of the rotorcraft.

According to the disclosure, such a method is remarkable in that the periodic determination of the emergency landing profile is generated depending on a predetermined rate of sink of the rotorcraft.

In other words, the generation of the emergency landing profile may comprise a sub-step of controlling the current speed of rotation of the main rotor or rotors and a sub-step of controlling the rate of sink of the rotorcraft, the sub-step of controlling the current speed of rotation of the main rotor or rotors then being carried out with priority over the sub-step of controlling the rate of sink of the rotorcraft.

In addition, the sub-step of controlling the rate of sink of the rotorcraft makes it possible to prompt the pilot or the autopilot of the rotorcraft to actuate control members such as a lever or a stick controlling the pitch of the blades of the rotor in order to cause the pitch of these blades to vary collectively or cyclically. In addition, the pilot is not required to keep the rotorcraft in a substantially horizontal attitude and can, in particular, pitch the rotorcraft nose down or up, if necessary.

Thus, such a sub-step of controlling the rate of sink of the rotorcraft makes it possible to contribute to the rotational drive rotating the rotor and consequently keep it above the minimum speed of rotation while limiting the power consumed by the engine still in operation. The pilot may therefore be prompted to act on a collective pitch lever in order to follow the predetermined rate of sink and not on a throttle control in order to maintain the speed of rotation of the rotor.

The generation of the emergency landing profile depending on the rate of sink of the rotorcraft thus makes it possible to limit the demands placed on the engine or engines still in operation when another engine has failed.

Furthermore, when the power delivered by the engine or engines still in operation of the at least two engines is sufficient, the periodic determination of the emergency landing profile may be generated in such a way that both a rotational speed target of the rotor and a rate of sink target are met.

However, when the power delivered by the engine or engines still in operation of the at least two engines is insufficient, the periodic determination of the emergency landing profile may be generated in such a way that only the rotational speed target of the rotor is met.

In practice, the predetermined rate of sink may be variable depending on the current height of the rotorcraft.

In other words, the sub-step of controlling the rate of sink of the rotorcraft may make it possible to modify the current value of the predetermined rate of sink that is to be observed, depending on the height at which the rotorcraft is located. In practice, the closer the rotorcraft is to the ground, the lower the value of the predetermined rate of sink may be.

Thus, when the current height of the rotorcraft is greater than or equal to 200 feet (60.96 meters), the predetermined rate of sink may be equal to a first threshold value of between −1200 and −800 feet per minute (between −365.76 and −243.84 meters per minute).

Furthermore, when the current height of the rotorcraft is less than or equal to 100 feet (30.48 meters), the predetermined rate of sink may be equal to a second threshold value of between −700 and −300 feet per minute (between −213.36 and −91.44 meters per minute).

Similarly, when the current height of the rotorcraft is between 100 and 200 feet (30.48 and 60.96 meters), the predetermined rate of sink may vary according to a linear decreasing function between a first threshold value of between −1200 and −800 feet per minute (between −365.76 and −243.84 meters per minute) and a second threshold value of between −700 and −300 feet per minute (between −213.36 and −91.44 meters per minute).

For example, the predetermined rate of sink may be chosen at a value of −1000 feet per minute (−304.8 meters per minute) when the current height is greater than 200 feet (60.96 meters) and may decrease linearly to −500 feet per minute (−152.4 meters per minute), remaining at this predetermined value at heights below 100 feet (30.48 meters).

In practice, the minimum speed of rotation (NRmin) may be a predetermined and fixed value lying between 94% and 105% of a memorized nominal speed of rotation (NRnom) of the at least one main rotor.

For example, the nominal speed of rotation (NRnom) may be 321.6 rpm (revolutions per minute) and the minimum speed of rotation (NRmin) may be chosen to be equal to 102% of this value, i.e., approximately 328.2 rpm (revolutions per minute).

Furthermore, the nominal speed of rotation (NRnom) of the at least one main rotor is a speed of rotation enabling the rotorcraft to carry out a cruising flight phase at a constant speed and height, for example. In addition, the minimum speed of rotation (NRmin) may be chosen to be greater than the nominal speed of rotation (NRnom) because such a piloting assistance method is implemented in a flight phase different from a cruising flight phase, such as take-off or landing phases.

Advantageously, the at least one main rotor including at least two blades, the control orders may collectively modify a pitch of each of the at least two blades.

Such control orders are then transmitted to servocontrols or actuating cylinders making it possible, for example, to move at least one swashplate collectively modifying the pitch of the blades. This collective modification of the pitch of the blades thus makes it possible to control both the speed of rotation of the main rotor, so that it does not drop below the minimum speed of rotation (NRmin), and the rate of sink of the rotorcraft.

According to one embodiment of the disclosure compatible with the preceding embodiments, the periodic determination of the emergency landing profile may depend on a maximum longitudinal acceleration of the rotorcraft relative to the ground, and on a maximum longitudinal forward speed of the rotorcraft relative to the ground.

In other words, the emergency landing profile also places constraints on the piloting of the rotorcraft with respect to its pitch axis. Indeed, in order to be able to land safely at the touchdown point, the rotorcraft must be able to reduce its longitudinal speed, i.e., its speed in a direction leading from a rear zone towards a front zone of the rotorcraft. Moreover, such a reduction in longitudinal speed is implemented by modifying the control orders to control the aerodynamic members, making it possible to modify a pitch angle of the rotorcraft.

Such constraints on the pitch control of the rotorcraft are generated during the step of periodically determining an emergency landing profile, and prevent the rotorcraft from exceeding these maximum longitudinal acceleration and maximum longitudinal forward speed values.

In practice, the maximum longitudinal acceleration of the rotorcraft may be variable as a function of a current height of the rotorcraft and a power margin of the at least two engines when the rotorcraft is in a hovering flight phase with a vertical speed of zero.

In other words, the maximum longitudinal acceleration value that the rotorcraft cannot exceed is not fixed and may vary over time, depending on the current height of the rotorcraft and the power margin of the at least two engines when the rotorcraft is hovering.

For example, the maximum longitudinal acceleration may be between 0.5 and 1.5 meters per second squared (m·s⁻²).

More precisely, this maximum longitudinal acceleration that must not be exceeded may be between 0.75 and 1 meters per second squared (m·s⁻²).

Similarly, the maximum longitudinal speed may be variable as a function of a current rate of sink of the rotorcraft.

Therefore, the maximum longitudinal speed threshold value that must not be exceeded is not fixed and may also vary over time, depending on the current rate of sink of the rotorcraft.

Advantageously, the assistance method may include at least one step of displaying, on a display device, information representative of a first difference between the current position and the touchdown point.

Displaying this first difference in this way allows the pilot to quickly and effortlessly monitor the implementation of such a method for assisting the piloting of a rotorcraft. Moreover, such monitoring is particularly beneficial when the control orders for controlling the aerodynamic members are generated automatically by the autopilot system of the rotorcraft.

Such an arrangement makes it possible, in particular, to reduce the workload of the crew when an engine failure occurs. The crew can then very easily check that the rotorcraft is approaching the touchdown point in a safe manner.

Alternatively, or additionally, the assistance method may include at least one step of displaying, on a display device, information representative of a second difference between the current position and a zone comprising an obstacle.

As previously for the first difference, such a step of displaying information representative of a second difference allows the pilot to quickly and effortlessly monitor the implementation of the piloting assistance method.

According to one embodiment of the disclosure, the displayed information may be representative of an azimuthal angular position of the rotorcraft as a function of the current position of the rotorcraft with respect to the touchdown point and/or with respect to the zone comprising an obstacle.

An angular sector is then displayed in a perspective view of a compass dial comprising a circular or elliptical graduated scale and at least one piece of heading information. The color, shape and/or width of this angular sector may be modified as a function of the value of the first or second difference.

The displayed information can be used to provide an alarm signal when, for example, one of the differences is less than a predetermined threshold value.

For example, several alarm levels may be provided, using several predetermined threshold values. A first alarm level may then be indicated to the pilot by displaying a colored angular sector, for example in orange, when a first predetermined threshold value is passed. A second alarm level may be indicated to the pilot by displaying a colored angular sector, for example in red, when a second predetermined threshold value, different from the first predetermined threshold value, is passed.

According to another embodiment of the disclosure compatible with the preceding embodiments, the method may include at least one step of displaying, on a display device, information representative of a third difference between the current height of the rotorcraft and the predetermined height of the decision point.

Such a third difference is then advantageously represented by means of a vertical graduated scale and a colored bar, the color of which may vary as a function of the value of this third difference.

As before, the displayed information can be used to provide a visual alarm signal when this third difference falls below a predetermined threshold value.

For example, several alarm levels may be envisaged, using several predetermined threshold values.

The colored bar may change from an initial green color to orange, for example, when a first predetermined threshold value is passed. A second alarm level may be indicated to the pilot by displaying a red-colored bar when a second predetermined threshold value, different from the first predetermined threshold value, is passed.

Moreover, a take-off or landing decision point may be displayed with this third difference. The position of this decision point then corresponds to the end of the colored bar. Once this decision point has been passed, the pilot of the rotorcraft can then manually control an automated “GO AROUND” or “FLY AWAY” phase.

During take-off or landing, a button actuated by the pilot then makes it possible to engage the GO AROUND mode if the rotorcraft is at a current height greater than the height of the decision point.

The pilot can always enter the GO AROUND mode, even in the event of an engine failure.

During a take-off phase, the take-off decision point, which can be input by the pilot in advance, is displayed with a path of the rotorcraft in order to enable the pilot to decide whether or not a GO AROUND manoeuvre needs to be performed.

When climbing, at take-off, the rotorcraft climbs until the pilot activates the GO AROUND button or until an engine failure is identified. In the event of an engine failure, the rotorcraft then automatically lands at the touchdown point from where it took off.

When descending, during approach, the rotorcraft lands by following a predefined three-dimensional path, if no engine fault or malfunction is detected. On the other hand, if an engine failure is identified, the assistance method implements the periodic generation of control orders to control the aerodynamic members and pilot the rotorcraft to follow the emergency landing profile depending at least on the minimum speed of rotation (NRmin) of the at least one main rotor and possibly also the predetermined rate of sink.

Except in the event of an engine failure, the pilot can also operate the GO AROUND button at any time. The landing decision point is displayed with a three-dimensional landing path in order to help the pilot's decision-making.

As before, if an engine failure is identified, a three-dimensional path is no longer followed, the rotorcraft instead being piloted to follow the emergency landing profile depending at least on the speed of rotation of the rotor or rotors and possibly also the rate of sink of the rotorcraft.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a schematic diagram of a rotorcraft allowing the assistance method according to the disclosure to be implemented;

FIG. 2 is a logic diagram showing the steps of an assistance method according to the disclosure;

FIG. 3 is a side view showing emergency landing phases of a rotorcraft;

FIG. 4 is a view showing a first display step of the assistance method according to the disclosure;

FIG. 5 is a view showing a second display step of the assistance method according to the disclosure;

FIG. 6 is a view showing a third display step of the assistance method according to the disclosure; and

FIG. 7 is a view showing a fourth display step of the assistance method according to the disclosure.

### DETAILED DESCRIPTION

Elements that are present in more than one of the figures are given the same references in each of them.

As already mentioned, the disclosure relates to a method for assisting the piloting of a rotorcraft.

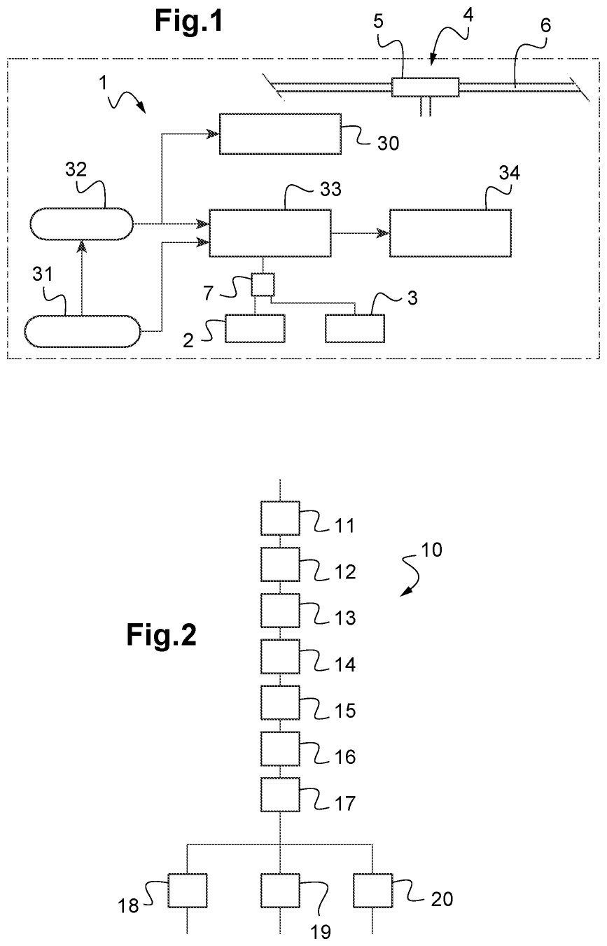

As shown in FIG. 1, such a rotorcraft 1 includes at least two engines 2, 3 capable, in the absence of a failure, of transmitting engine torque to at least one main rotor 4 providing at least lift keeping the rotorcraft 1 in the air. Such a main rotor 4 comprises at least two blades 6 forming at least one of the aerodynamic members 5 for piloting the rotorcraft 1.

In addition, such a rotorcraft 1 also comprises actuators 34 such as servo-controls or actuating cylinders for moving the aerodynamic members 5 such as, for example, the blades 6, flaps or else fins that are used to pilot the rotorcraft 1.

These actuators 34 can thus receive control orders generated by means of a control unit 33 such as, for example, a control unit of an autopilot system referred to as an automatic flight control system and known by the acronym AFCS.

Furthermore, such a rotorcraft 1 also comprises sensors 32 connected to the control unit 33 by wired or wireless means. Such sensors 32 may in particular comprise sensors for detecting the position, speed or acceleration of the rotorcraft 1, an inertial unit, and an anemobarometric system, for measuring and transmitting to the control unit 33 the effects caused by the control orders transmitted to the actuators 34.

The rotorcraft 1 may also comprise at least one mission system 31 connected to the control unit 33 and to the sensors 32 by wired or wireless means. Such a mission system 31 is configured to set the parameters of the control unit 33 and possibly the sensors 32 depending on flight constraints related to the mission that is to be performed by the rotorcraft 1 or piloting preferences.

This mission system 31 may in particular comprise a human-machine interface enabling the pilot to input preferences relating to the emergency landing profile.

Therefore, in the event of a failure of one of the at least two engines 2, 3, a method 10 for assisting the piloting of the rotorcraft 1 as shown in FIG. 2 can be implemented.

Such an assistance method 10 thus comprises a plurality of steps and, in particular, optionally, a preliminary step of determining 11 a decision point TDP, LDP and a touchdown point PP. Determining 11 a decision point TDP, LDP in this way may, for example, be implemented by means of the mission system 31, which then transmits a signal representative of the decision point TDP, LDP and the touchdown point PP to the control unit 33.

The decision point can then be a take-off decision point TDP and/or a landing decision point LDP. Indeed, depending on the type of flight phase during which a failure occurs in an engine 2, 3, information relating to two different decision points may be useful in order to implement the assistance method.

The touchdown point PP may be the landing point if the rotorcraft 1 is in the landing phase or the initial take-off point if the rotorcraft 1 is in the take-off phase. The control unit 33 is also able to determine whether the rotorcraft is in the take-off or landing phase depending, in particular, on the piloting orders it generates.

Once this step of determination 11 has been implemented, the rotorcraft 1 can then carry out or begin its mission.

The assistance method 10 then comprises a step of periodically determining 12 a current position of the rotorcraft 1. Such a current position of the rotorcraft 1 is then defined in a reference frame, for example a terrestrial reference frame, the origin of which is the touchdown point.

Such a step of periodic determination 12 may be carried out by means of the sensors 32 and/or other sensors comprising, in particular, a receiver of a satellite positioning system.

The sensors 32 can therefore be used to measure the current position of the rotorcraft 1 and thus transmit a signal representative of the current position of the rotorcraft 1 to the control unit 33.

The method 10 also comprises a step of making a first periodic comparison 13 between the current position and the decision point TDP, LDP. This first periodic comparison 13 makes it possible to identify that the current height of the current position of the rotorcraft 1 is less than a predetermined height of the decision point TDP, LDP.

This first periodic comparison 13 can thus be made on the basis of the signal representative of the current position of the rotorcraft 1 and the signal representative of the decision point TDP, LDP, by the control unit 33. Such a control unit 33 is thus equipped with a processing unit comprising a computer or a comparator for periodically making comparisons between the current height and the predetermined height of the decision point TDP, LDP. This first periodic comparison 13 thus makes it possible to implement a sub-step of identifying that the current height of the rotorcraft 1 is less than the predetermined height.

The assistance method 10 then comprises a step of identifying a failure 14 of at least one of the at least two engines 2, 3. Such a step of identifying a failure 14 may be implemented, for example, by means of a system 7 known by the acronym FADEC, corresponding to the expression “Full Authority Digital Engine Control”. Such a FADEC system 7 can be used to identify an engine failure of one of the engines 2, 3 and then transmits a signal representative of this identification of an engine failure 14 to the control unit 33.

For example, the FADEC system 7 may comprise sensors measuring a drop in engine torque on a drive shaft of the faulty engine 2, 3, or indeed pressure or temperature sensors measuring an operating fault of the engine 2, 3.

The FADEC system 7 may in particular comprise a processing unit comprising a computer or a comparator for comparing the sensor measurements, for example torque, pressure or temperature measurements, with predetermined threshold values. When one of the predetermined threshold values is passed by the measured values, this processing unit can identify a fault in an engine 2, 3.

Furthermore, the assistance method 10 comprises a step of making a second periodic comparison 15 between the current position of the rotorcraft 1 and the touchdown point PP.

This second periodic comparison 15 may thus be made by the control unit 33 provided with a processing unit comprising, in particular, a computer or a comparator for periodically making comparisons between the current position determined and transmitted by the sensors 33 and the touchdown point PP determined and transmitted by the mission system 31.

The assistance method 10 comprises a step of periodically determining 16 an emergency landing profile, said emergency landing profile being generated at least depending on a result of the second periodic comparison step 15. In addition, such a step of periodically determining 16 the emergency landing profile is implemented depending on a minimum speed of rotation NRmin of the at least one main rotor 4 and possibly also a predetermined rate of sink of the rotorcraft 1.

This step of periodically determining 16 an emergency landing profile can thus be implemented by the control unit 33 equipped with a processing unit comprising, in particular, a computer for periodically calculating the minimum speed of rotation NRmin of the at least one main rotor 4 and, possibly, the predetermined rate of sink of the rotorcraft 1.

Such a calculation of the predetermined rate of sink of the rotorcraft 1 may, for example, use a table of values stored in a memory, variation laws as a function of one or more parameters and/or mathematical equations.

The assistance method 10 comprises a step of periodically generating 17 control orders to control the aerodynamic members 5 and pilot the rotorcraft 1 according to the emergency landing profile.

Therefore, such a step of periodically generating 17 control orders can thus be implemented by the control unit 33 equipped with a processing unit comprising, in particular, a computer for periodically performing calculations in order to check that the speed of rotation of the main rotor 4 does not drop below the minimum speed of rotation NRmin and possibly also that the rotorcraft 1 is correctly following the predetermined rate of sink.

This control unit 33 also makes it possible to modify the control orders of the aerodynamic members 5 in order to control the speed of rotation of the main rotor 4 and possibly also the rate of sink of the rotorcraft 1 when the available power is sufficient.

The step of periodically generating 17 control orders then makes it possible, for example, to collectively modify the pitch of each of the blades 6 of the main rotor 4.

Furthermore, the steps of making a first periodic comparison 13, identifying a failure 14, making a second periodic comparison 15, periodically determining 16 the emergency landing profile and periodically generating 17 control orders can be implemented by the control unit 33 equipped with several separate processing units or else by a single processing unit allowing the various abovementioned steps of the method to be implemented.

Alternatively, when the available power is insufficient, the periodic determination 16 of the emergency landing profile can comply only with the minimum speed of rotation NRmin of the at least one main rotor 4 and not comply with the predetermined rate of sink of the rotorcraft 1.

Furthermore, the periodic determination 16 of the emergency landing profile may also be implemented by the control unit 33 in such a way that the rotorcraft 1 complies with a maximum longitudinal acceleration relative to the ground and a maximum longitudinal forward speed relative to the ground.

Such a maximum longitudinal acceleration of the rotorcraft 1 may in particular be calculated by the control unit and vary as a function of the current height of the rotorcraft 1 measured and transmitted by means of the sensors 32 and a predetermined power margin of the at least two engines when the rotorcraft 1 is in a phase of hovering flight with a vertical speed of zero. For example, such a power margin may be stored in a memory of the control unit 33.

For example, this maximum longitudinal acceleration of the rotorcraft 1 may be between 0.5 and 1.5 meters per second squared (m·s⁻²).

The maximum longitudinal speed may also be variable as a function of a current rate of sink of the rotorcraft 1.

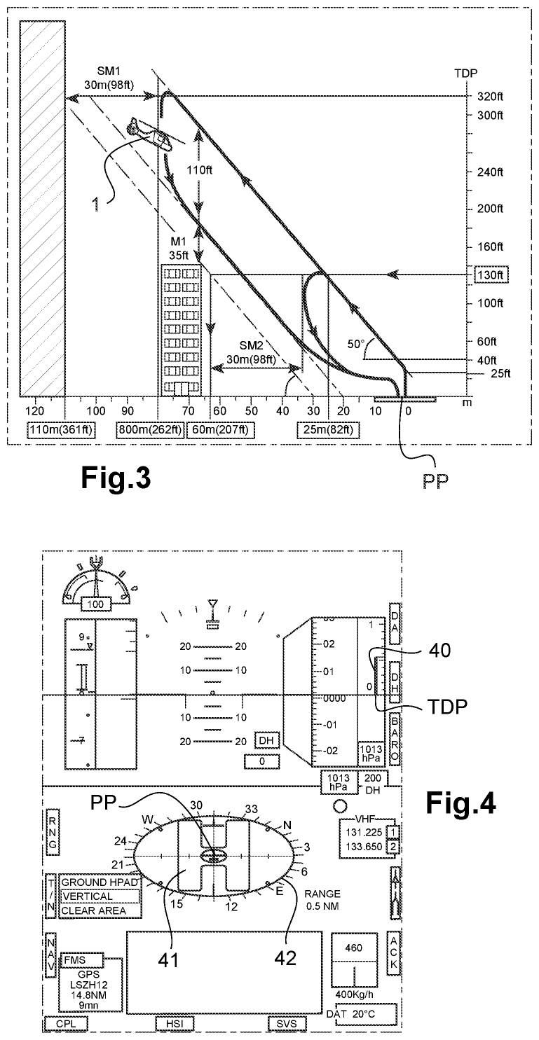

As shown in FIG. 3, several emergency landing profiles can be generated depending on the height of the rotorcraft 1 at the time an engine failure is identified 14. Such emergency landing profiles may in particular be distinguished from one another, for example, as a function of the current position of the rotorcraft 1 when the failure of an engine 2, 3 is identified.

Thus, the predetermined rate of sink may be variable depending on the current height of the rotorcraft 1.

For example, if the current height of the rotorcraft 1 is greater than or equal to 200 feet (60.96 meters), the predetermined rate of sink may be equal to a first threshold value of between −1200 and −800 feet per minute (between −365.76 and −243.84 meters per minute).

On the other hand, if the current height of the rotorcraft 1 is less than or equal to 100 feet (30.48 meters), the predetermined rate of sink may be equal to a second threshold value of between −700 and −300 feet per minute (between −213.36 and −91.44 meters per minute).

If the current height of the rotorcraft 1 is between 100 and 200 feet (30.48 and 60.96 meters), the predetermined rate of sink may vary according to a linear decreasing function between this first threshold value of between −1200 and −800 feet per minute (between −365.76 and −243.84 meters per minute) and this second threshold value of between −700 and −300 feet per minute (between −213.36 and −91.44 meters per minute).

Thus, the control unit 33 may also comprise a memory for storing this first threshold value and this second threshold value. The control unit 33 is then connected by wired or wireless means to a sensor for measuring the current height of the rotorcraft 1, such as a radiosonde. The control unit 33 is thus configured to adapt the rate of sink of the emergency landing profile depending on the current height of the rotorcraft 1.

According to one advantageous example, the minimum speed of rotation NRmin may be a predetermined and fixed value lying between 94% and 105% of a nominal speed of rotation NRnom of the at least one main rotor 4. In this way, such a minimum speed of rotation NRmin can be stored in a memory of the processing unit.

In addition, longitudinal safety margins SM1, SM2 oriented in a longitudinal direction may also be used to avoid any collision with an obstacle situated in a rear zone behind the rotorcraft 1. Such longitudinal safety margins SM1, SM2 may, for example, be 30 meters (approximately 98 feet).

Similarly, vertical safety margins M1 oriented in a vertical direction may also be used to avoid any collision with an obstacle located in a lower zone beneath the rotorcraft 1. Such vertical safety margins M1 may, for example, be 10 meters (approximately 35 feet).

As shown in FIG. 2, the assistance method 10 may also include display steps 18, 19, 20 enabling the pilot of the rotorcraft 1 to quickly monitor the correct operation of the assistance method 10.

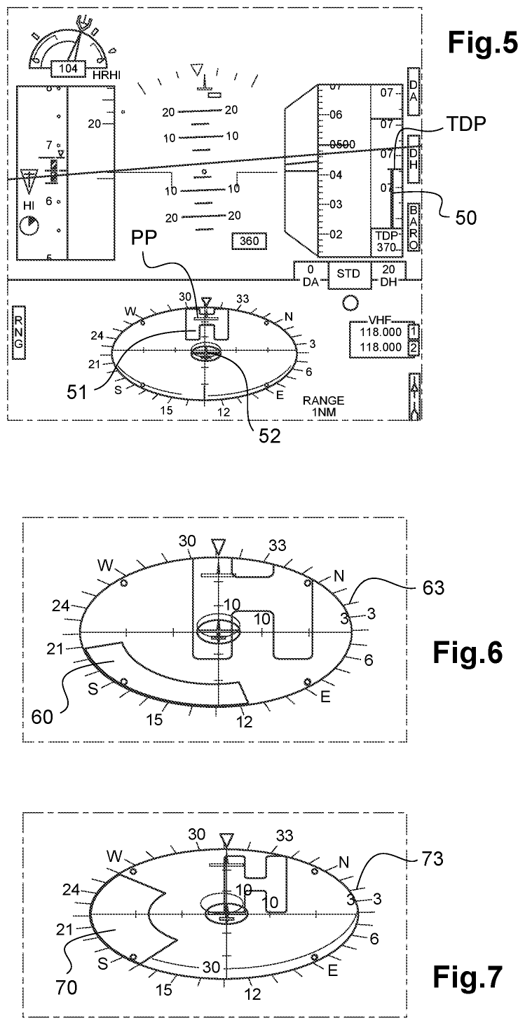

As shown in FIGS. 4 and 5, this display step 18 is implemented by means of the display device 30 and makes it possible to display information representative of a first difference between the current position and the touchdown point PP.

The current position is shown here on the display device 30 by means of a first cue 42, 52. The touchdown point PP is shown by a second cue and an H shape 41, 51 centered on the touchdown point PP.

The first difference may be represented by a distance separating the first cue 42, 52 from the second cue or from the H shape 41, 51. The H shape symbolizes, for example, a helicopter landing pad such as a heliport.

As shown in FIG. 4, the assistance method 10 can allow a purely vertical take-off phase to be carried out. In this case, the H shape remains centered on the first cue 42 but the H grows gradually smaller as the altitude of the rotorcraft increases, then grows larger again if an emergency landing phase is implemented.

According to FIG. 5, the assistance method 10 can allow a take-off phase to be carried out in a reversing direction, as also shown in FIG. 3. In this case, the H shape 51 then moves off the first cue 52 as the rotorcraft 1 increases in altitude.

As shown in FIGS. 6 and 7, the display step 19 on the display device 30 makes it possible to display information representative of a second difference between the current position and a zone comprising an obstacle.

The displayed information is representative of an azimuthal angular position of the rotorcraft as a function of its current position with respect to said touchdown point PP and/or with respect to said zone comprising an obstacle.

An angular sector 60, 70 is then displayed in a perspective view of a compass dial 63, 73 comprising a circular or elliptical graduated scale and at least one piece of heading information. The color, shape and/or width of this angular sector 60, 70 may be modified as a function of the value of the first or second difference.

The displayed information can be used to provide an alarm signal when, for example, one of the differences is less than a predetermined threshold value.

For example, several alarm levels may be provided, using several predetermined threshold values. As shown in FIG. 6, a first alarm level may be indicated to the pilot by displaying a colored angular sector 60, for example in orange and/or with a first thickness, when a first predetermined threshold value is passed. As shown in FIG. 7, a second alarm level may be indicated to the pilot by displaying a colored angular sector 70, for example in red and/or with a second thickness greater than the first thickness, when a second predetermined threshold value, different from the first predetermined threshold value, is passed.

As shown in FIGS. 4 and 5, the display step 20 may make it possible to display, on the display device 30, information representative of a third difference between the current height of the rotorcraft 1 and the predetermined height of the decision point TDP, LDP.

Such a third difference is represented here by means of a colored bar 40, 50 extending between the predetermined height of the decision point TDP and the current height of the rotorcraft 1.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A method for assisting the piloting of a rotorcraft including at least two engines capable, in the absence of a failure, of transmitting engine torque to at least one main rotor providing at least lift keeping the rotorcraft in the air, the rotorcraft comprising aerodynamic members for piloting the rotorcraft, the assistance method including the following steps:
periodically determining a current position of the rotorcraft;
making a first periodic comparison between the current position and a decision point, the first periodic comparison enabling to determine that the current position of the rotorcraft has a current height less than a predetermined height of the decision point;
identifying an engine failure in at least one engine of the at least two engines;
making a second periodic comparison between the current position of the rotorcraft and a touchdown point;
periodically determining an emergency landing profile, the emergency landing profile being generated at least depending on a result of the second periodic comparison, the periodic determination of the emergency landing profile depending on a minimum speed of rotation of the at least main rotor; and
periodically generating control orders to control the aerodynamic members and pilot the rotorcraft according to the emergency landing profile, the periodic generation of control orders being implemented when the current position of the rotorcraft has a current height less than the predetermined height of the decision point, and an engine failure is identified,
wherein the periodic determination of the emergency landing profile depends on a predetermined rate of sink of the rotorcraft.

2. The method according to claim 1,
wherein the predetermined rate of sink is variable depending on the current height of the rotorcraft.

3. The method according to claim 2,
wherein, when the current height of the rotorcraft is greater than or equal to 200 feet (60.96 meters), the predetermined rate of sink is equal to a first threshold value of between −1200 and −800 feet per minute (between −365.76 and −243.84 meters per minute).

4. The method according to claim 2,
wherein, when the current height of the rotorcraft is less than or equal to 100 feet (30.48 meters), the predetermined rate of sink is equal to a second threshold value of between −700 and −300 feet per minute (between −213.36 and −91.44 meters per minute).

5. The method according to claim 2,
wherein, when the current height of the rotorcraft is between 100 and 200 feet (30.48 and 60.96 meters), the predetermined rate of sink varies according to a linear decreasing function between a first threshold value of between −1200 and −800 feet per minute (between −365.76 and −243.84 meters per minute) and a second threshold value of between −700 and −300 feet per minute (between −213.36 and −91.44 meters per minute).

6. The method according to claim 1,
wherein the minimum speed of rotation is a predetermined and fixed value lying between 94% and 105% of a memorized nominal speed of rotation of the at least main rotor.

7. The method according to claim 1,
wherein, the at least main rotor including at least two blades, the control orders collectively modify a pitch of each of the at least two blades.

8. The method according to claim 1,
wherein the periodic determination of the emergency landing profile depends on a maximum longitudinal acceleration of the rotorcraft relative to the ground, and on a maximum longitudinal forward speed of the rotorcraft relative to the ground.

9. The method according to claim 8,
wherein the maximum longitudinal acceleration of the rotorcraft is variable as a function of a current height of the rotorcraft and a power margin of the at least two engines when the rotorcraft is in a hovering flight phase with a vertical speed of zero.

10. The method according to claim 8,
wherein the maximum longitudinal acceleration is between 0.5 and 1.5 meters per second squared (m·s⁻²).

11. The method according to claim 8,
wherein the maximum longitudinal speed is variable as a function of a current rate of sink of the rotorcraft.

12. The method according to claim 1,
wherein the assistance method comprises at least one step of displaying, on a display device, information representative of a first difference between the current position and the touchdown point.

13. The method according to claim 1,
wherein the assistance method includes at least one step of displaying, on a display device, information representative of a second difference between the current position and a zone comprising an obstacle.

14. The method according to claim 12,
wherein the displayed information is representative of an azimuthal angular position of the rotorcraft as a function of the current position with respect to the touchdown point and/or with respect to the zone comprising an obstacle.

15. The method according to claim 1,
wherein the assistance method includes at least one step of displaying, on a display device, information representative of a third difference between the current height of the rotorcraft and the predetermined height of the decision point.
